(19) United States
(12) Patent Application Publication
(10) Pub. No.: US 2017/0016613 A1
(43) Pub. Date: Jan. 19, 2017

(54) MULTIFUNCTIONAL INSTRUMENT WITH COMBINATION FLASHLIGHT AND STYLUS

(71) Applicant: David A. Laemle, Westwood, NJ (US)

(72) Inventor: David A. Laemle, Westwood, NJ (US)

(21) Appl. No.: 15/211,107

(22) Filed: Jul. 15, 2016

Related U.S. Application Data
(60) Provisional application No. 62/192,647, filed on Jul. 15, 2015.

(51) Int. Cl. F21V 33/00; F21V 23/04; B43K 29/10; G06F 3/0354

(52) U.S. Cl. CPC F21V 33/0052; G06F 3/03545; F21V 23/0428; B43K 29/10; F21Y 2115/10

(57) ABSTRACT

A multifunctional instrument includes a housing, a writing member positioned in the housing with a writing tip accessible from the housing, a stylus positioned at one end of the housing and having an aperture, and an illumination device positioned inside the stylus, wherein the illumination device emits a light through the aperture when activated.

### FIELD OF THE INVENTION

The present invention relates to the field of hand-held instruments that combine multiple additional functions. In particular, the present invention relates to a multifunctional instrument having an illumination device embedded into a stylus.

### BACKGROUND OF THE INVENTION

In the modern technology world, it is often no longer convenient for consumers to carry a writing instrument, such as a pen, that only performs the conventional function of writing on paper. Nowadays, almost everyone uses personal electronic devices with touchscreens and it is therefore desirable to use a multifunctional instrument that provides both capabilities of writing on paper and interacting with a touch screen device. It is also often desirable to provide an illumination device combined with the multifunctional instrument to allow the user to use is as a flashlight and/or make it possible for the user to write in the dark.

However, most of the available multifunctional instruments still only allow for only one or two of the above-described functions. Additionally, many of the existing devices are bulky, not aesthetically pleasing and/or not very user-friendly.

It is therefore desirable to provide an improved multifunctional instrument that provides a variety of functions, including, a stylus function, an illumination function, and/or conventional writing function. It is also desirable to provide an improved multifunctional instrument that combines multiple functions in a streamlined and easy to use design.

### SUMMARY OF THE INVENTION

In order to overcome the deficiencies of the prior art and to achieve at least some of the objects and advantages listed, the invention comprises a multifunctional instrument that includes a stylus and an integrated illumination device. The multifunctional instrument may be any product, such as, e.g., a keychain, carabiner, etc. In other exemplary embodiments, the multifunctional instrument includes a stylus with an integrated illumination device combined with a writing instrument.

In some embodiments, the multifunctional instrument including a housing, a writing member positioned in the housing with a writing tip accessible from the housing, a stylus positioned at one end of the housing and having an aperture, and an illumination device, wherein the illumination device emits a light through the aperture when activated.

In certain embodiments, the illumination device is positioned inside the stylus. In additional embodiments, the illumination device is positioned inside the housing adjacent the stylus.

In some embodiments, the stylus is positioned at a proximal end of the housing and the writing member is positioned at a distal end of the housing. In other embodiments, both the stylus and the writing tip are positioned at the same end of the housing. In some of these embodiments, the stylus has an aperture the writing tip extends out of the aperture when in an activated position. In additional embodiments, the illumination device emits a light through the aperture when the writing tip is positioned inside the stylus in an inactivated position. In further embodiments, the illumination device is positioned around the writing tip. In yet further embodiments, the illumination device is positioned behind the writing tip such that it emits light ahead of the writing tip. In additional embodiments, the illumination device emits light when the writing tip is extended out of the housing in an activated position.

In certain embodiments, the illumination device is activated and deactivated by depressing and releasing the illumination device. In other embodiments, the illumination device is activated and deactivated by depressing and releasing the stylus.

In some embodiments, the writing tip comprises at least one of a ball point tip, a fountain tip, a pencil tip, a felt tip, a marker tip, and a stylus tip.

In certain embodiments, the writing tip extends out of the housing when in an activated position and retracts inside the housing when in an inactivated position.

The invention further comprises a multifunctional instrument including a housing, a stylus positioned at one end of the housing, and an illumination device that emits a light through the aperture when activated.

In some embodiments, the illumination device is positioned inside the stylus. In additional embodiments, the illumination device is positioned inside the housing.

In certain embodiments, the illumination device is activated and deactivated by depressing and releasing the illumination device. In other embodiments, the illumination device is activated and deactivated by depressing and releasing the stylus.

In some cases, the illumination device is an LED.

In certain embodiments, the multifunctional instrument further includes a writing member having a writing tip. In some of these embodiments, the stylus is positioned at a proximal end of the housing and the writing member is positioned at a distal end of the housing. In additional embodiments, both the stylus and the writing tip are positioned at the same end of the housing.

In some cases, the multifunctional instrument further includes a removable cap member adapted to be positioned over at least one of the distal end and the proximal of the housing.

Other objects of the invention and its particular features and advantages will become more apparent from consideration of the following drawings and accompanying detailed description

### BRIEF DESCRIPTION OF THE DRAWINGS

FIG. 1 is a side view of the multifunctional instrument in accordance with the present invention.

FIG. 2 is an enlarged perspective view of a stylus end of the multifunctional instrument of FIG. 1.

FIG. 3 is an enlarged front view of the stylus end of FIG. 2.

FIG. 4A is a side view of the multifunctional instrument is accordance with the present invention, shown with a cap removed.

FIG. 4B is a side view of the multifunctional instrument of FIG. 4A, shown with the cap positioned over the writing tip.

FIG. 4C is a side view of the multifunctional instrument of FIG. 4A, shown with the cap positioned over the stylus.

FIG. 5A is side perspective view of the multifunctional instrument in accordance with the present invention, shown with the writing tip extended out of the stylus.

FIG. 5B is front enlarged view of the stylus tip of the multifunctional instrument of FIG. 5A.

FIG. 6 is a side view of the multifunctional instrument in accordance with the present invention.

FIG. 7 is an enlarged front perspective view of the stylus end of the multifunctional instrument of FIG. 6.

### DETAILED DESCRIPTION OF THE INVENTION

In some exemplary embodiments of the present invention, the multifunctional instrument comprises a stylus with an integrated illumination device. In other exemplary embodiments, the multifunctional instrument includes a stylus with an integrated illumination device and a writing instrument.

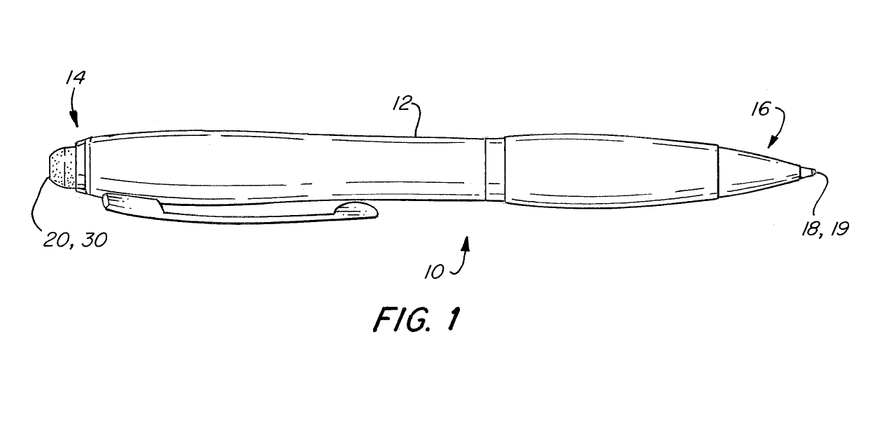

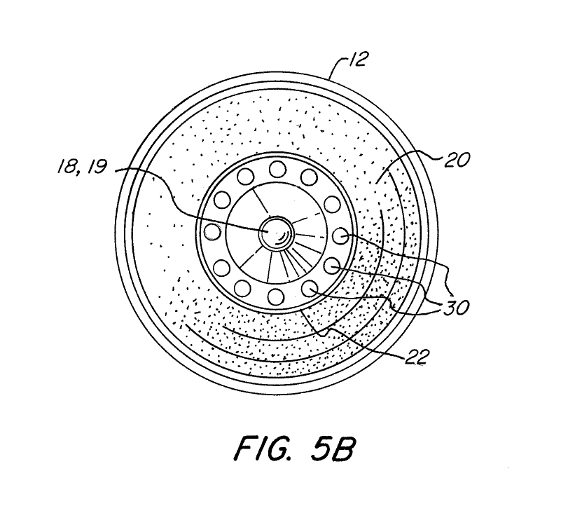

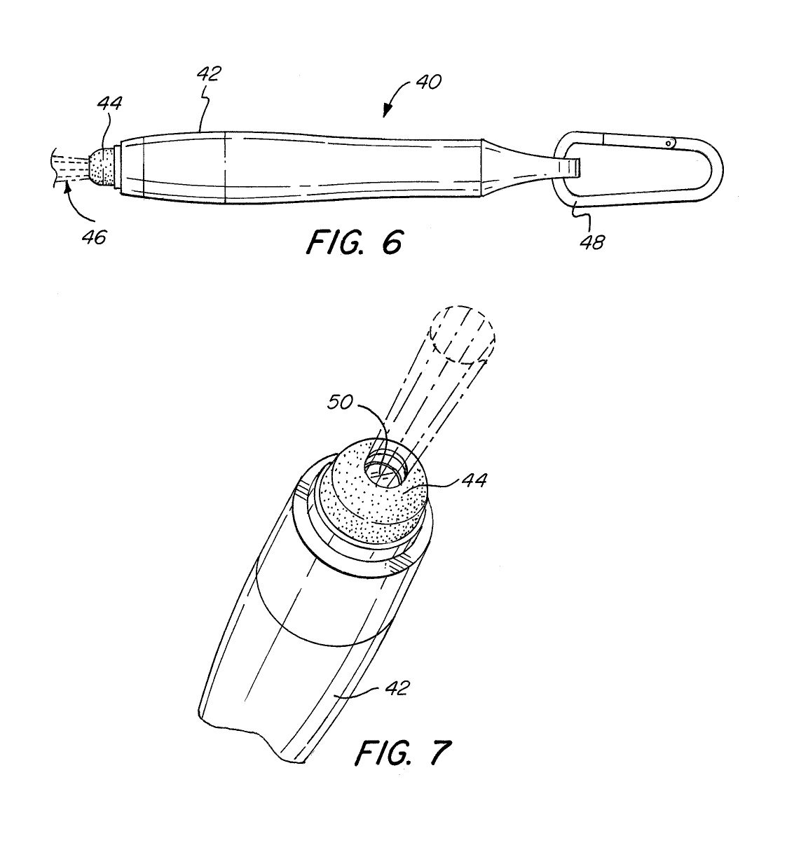

As shown in FIG. 1, one exemplary embodiment of the multifunctional instrument, for example, a pen (10), consists of a housing (12), a stylus (20) positioned at one end of the housing (12), and an illumination device (30) positioned inside the stylus (20). It is noted that in other embodiments, such as illustrated in FIGS. 6 and 7 and described in more detail below, the multifunctional instrument includes a stylus and an illumination device, without the writing function.

The housing (12) is a hollow tubular shaft which can be made of any suitable material, such as plastic or metal. The shaft can be made of two or more smaller sections joined together. The housing (12) has a proximal end (14) and a distal end (16). The housing (12) accommodates a writing member (18), actuators to deploy or retract the writing member, and electrical circuitry and power source for the illumination device (30). The distal end (16) of the housing (12) has an opening through which the writing member (18) extends out when the pen (10) is in use.

The writing member (18) can be any device configured for writing and which is positioned inside a writing instrument, such as an ink cartridge or a pencil lead. The writing member (18) has a corresponding writing tip (19) located at the distal end (16) of the housing (12). For example, the writing tip (19) can be a ball point tip, a fountain tip, a pencil tip, a felt tip, a marker tip, a stylus tip, or another type of writing tip, depending on the type of writing member. In the embodiment shown in FIG. 1, the writing tip (19) is a ball point tip.

In some embodiments, the writing member (18) may be deployed or retracted by pressing a button, or any other suitable actuator provided on the housing (12). This engages another actuator provided inside the housing (12) and causes the writing tip (19) to extend out of, or back into, the opening at the distal end (16) of the housing. In the embodiment shown in FIG. 1, the writing member (18) is deployed or retracted by rotating a section of the housing (12) to engage an actuator inside the housing. It is understood that any other suitable mechanism may be used to deploy or retract the writing member (18).

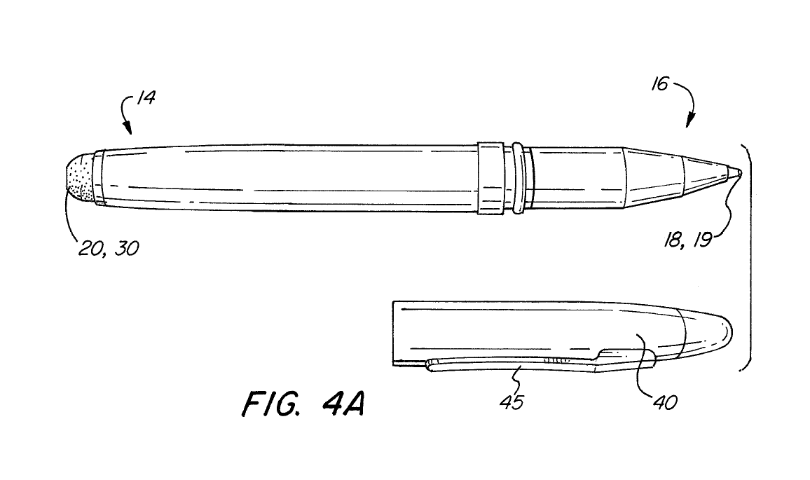

An illumination device (30) is positioned at the proximal end (14) of the housing (12). In the embodiment shown in FIG. 3, the illumination device (30) is an LED emitting visible light. However, the illumination device (30) can be an incandescent lamp or any other type of light source, and can emit any other spectrum of light, such as ultra-violet or infra red, depending on the use of the device. The illumination device (30) serves to operate the writing instrument (10) as a pen light.

The illumination device (30) is powered by a power source, such as a battery, positioned in the housing (12) and connected to the illumination device (30).

A pen light can be used in a variety of settings. It is a convenient means to carry a light source around without carrying an extra device. The most basic use of a pen light is as a flashlight to illuminate objects in the dark. Such use extends to more specialized settings such as hospitals, where medical personnel uses pen lights for diagnostic purposes, for example, to illuminate the back of a patient's throat during an oral examination. Other specialized uses include use by law enforcement officers to examine pupils of intoxicated suspects, or the use of a broad range of spectrums from ultra-violet to infra-red in forensic settings.

The illumination device (30) doubles as a push-button actuator for itself. Thus, to activate the illumination device (30), the device is pressed down and released. The same action turns off the illumination device (30). It is understood that any other suitable actuator may be used to turn the illumination device (30) on and off.

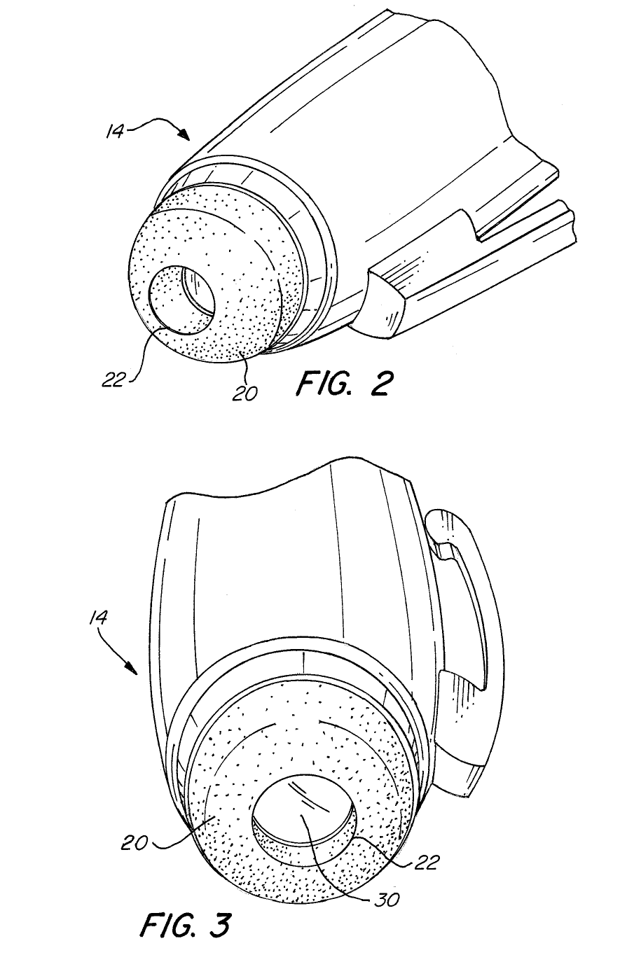

As shown in FIGS. 2 & 3, a stylus (20) is positioned at the proximal end (14) of the housing (12), covering the illumination device (30). The stylus (20) is an input tool used with touch screens on a variety of electronic devices such as smart phones, personal digital assistants, tablets, or laptop and desktop monitors. The stylus (20) serves to navigate interface elements and facilitates touch screen interactions such as handwriting or hand-drawing. Because a stylus is typically smaller and sharper than a finger, it is more precise. It also prevents oil smears from the user's fingers, thus helping keep touch screens clean.

The stylus (20) has a convex shape with curved edges. However, the stylus (20) may be any other suitable shape in accordance with the present invention, such as a pointed tip shape. The stylus (20) is hollow and covers the illumination device (30) located at the proximal end (14) of the housing (12). Thus, in some embodiments, the stylus (20) is sufficiently large to accommodate at least a top portion or the entirety of the illumination device (30). In other embodiments, the illumination device (30) is positioned inside the housing (12) adjacent the stylus (20) such that the illumination device does not occupy any part of the stylus.

The stylus (20) further has an aperture (22) through which the illumination device (30) is visible. In the embodiment shown in FIGS. 2 & 3, the aperture (22) is located at the tip of the illumination device (30). When the illumination device (30) is activated, its light shines through the aperture (22).

To turn on the illumination device (30), the stylus (20) is pressed down and released with sufficient force to press down and release the illumination device (30) through the stylus. Pressing down on the stylus (20) in the same manner turns off the illumination device (30). The illumination device's (30) push button actuator is configured such that the force required to depress the illumination device (30) to toggle it on or off is greater than the force required to press the stylus (20) against a touch screen and generate sufficient contact for interaction. This minimizes the risk of inadvertently toggling the illumination device while using the stylus.

As noted above, the illumination device (30) may be turned on and off via any other suitable actuation mechanism.

It is noted that in other embodiments, the stylus (20) may not be entirely hollow, but may instead be made with a suitable material having a channel therein, such that the illumination device (30) is positioned in the channel and the light emitted by the illumination device (30) is transmitted through the channel.

The stylus (20) is made with a conductive material, such as conductive rubber or any other conductive elastomeric material, and may have screen-protecting coating. Preferably, the material of the stylus tip (20) is deformable enough to generate a proper contact area when the stylus (20) is pressed against a screen of the electronic device. The material is also flexible enough to allow the user to depress the illumination device (30) through the stylus (20) to toggle the light on or off.

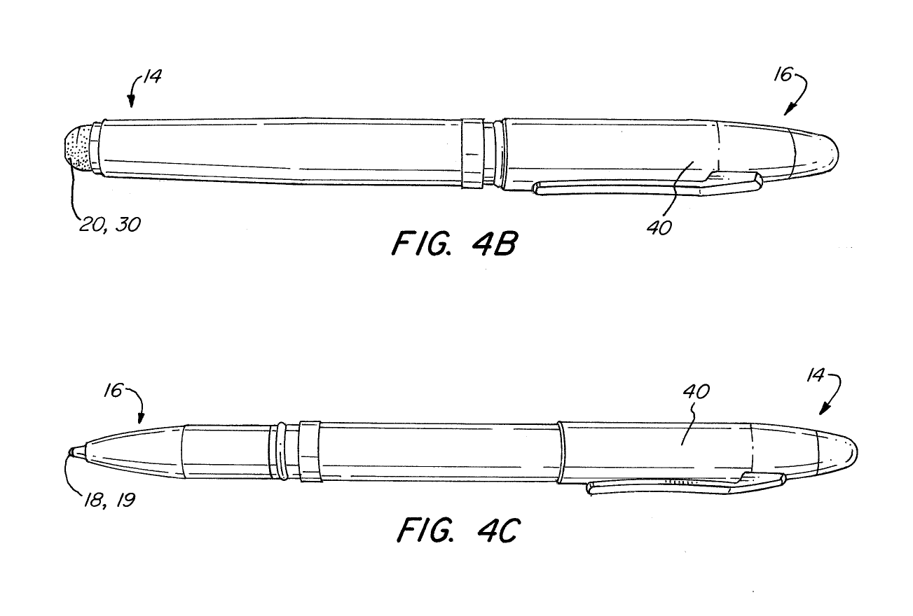

In some embodiments, as shown in FIGS. 4A-4C, the writing instrument (10) may include a removable cap portion (40). The cap portion (40) is a hollow, generally cylindrical tube that is closed at one end and open at the opposite end. In some embodiments, the cap portion (40) has the same shape as the proximal end (14) and/or or the distal end (16) of the housing (12). The cap portion can be made of any material such as plastic or metal. Typically, the cap portion is made of the same material as the housing (12). The cap portion (40) is sized to securely fit over the proximal end (14) or the distal end (16) of the housing (12). In some embodiments, such as illustrated in FIGS. 4B and 4C, the same cap portion (40) is sized to fit both ends of the housing (12). The cap portion may include a holder element (45) configured to secure the writing instrument (10) to various objects such as, e.g., the user's pocket or a book cover.

When the cap portion (40) covers the proximal end (14) of the housing, as shown in FIG. 4C, it serves to protect the stylus (20) and the illumination device (30) against damage from contact with the environment or the elements, for example from water in inclement weather. The cap portion (40) serves the same function with regard to the writing tip (19) when it covers the distal end (16), as shown in FIG. 4B, but also helps reduce ink evaporation from fountain, felt, and marker tips, or similar writing tips, and also protects surrounding objects, such as wearer's pocket, from being stained with ink.

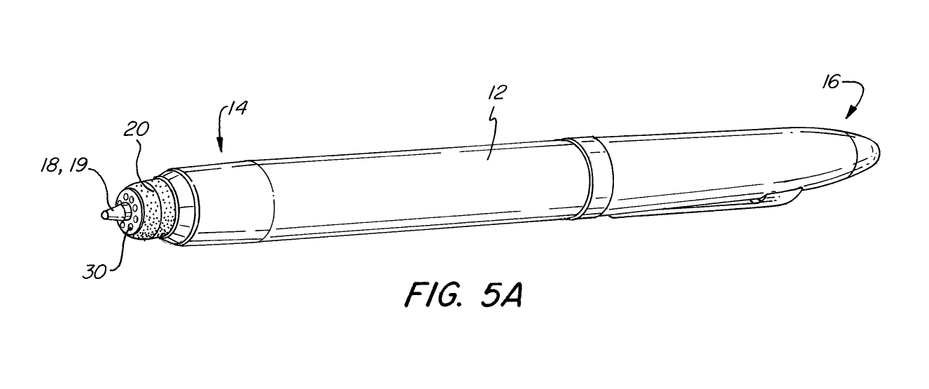

It should be noted that the writing instrument (10) shown in FIGS. 1-3 is only exemplary and that other embodiments are envisioned. For example, in some embodiments, such as illustrated in FIGS. 5A and 5B, the writing member (18) with the writing tip (19) is positioned at the same end (14) of the housing (12) as the stylus (20). The writing tip (19) extends out of the aperture in the stylus (20) when used as a pen, and is hidden inside the housing (12) when the writing instrument (10) is used as a stylus. The writing member (18) is actuated by pressing a button provided at the other end of the housing or by any other suitable actuator.

In some embodiment, the illumination device (30) is positioned inside the stylus (20) such that it emits light from the stylus through the aperture (22) when activated. In other embodiments, the illumination device (30) is positioned inside the housing (12) adjacent the stylus (20) and the light emitted by the illumination device is transmitted through the aperture in the stylus.

The illumination device (30) may be configured such that it surrounds the writing tip (19). The illumination device (30) may comprise a plurality of LEDs positioned around the writing tip (19), as illustrated in FIG. 5B, or may have any other suitable configuration. When the writing instrument (10) is used as a pen and the writing tip (19) is extended out of the housing, the illumination device (30) may be turned on to illuminate the space in front of the writing tip. This is particularly useful when a person is using the pen to write in a dark environment. In other embodiments, the illumination device (30) is tuned on when the writing tip (19) of the writing member (18) is retracted into the housing, such that the writing instrument (10) is used as a light, as described above.

FIGS. 6 and 7 illustrate another exemplary embodiment of the multifunctional instrument of the present invention. In embodiment, the multifunctional instrument (40) includes a housing (42) with a stylus (44) positioned at one end of the housing (42). The housing (42) is a hollow tubular shaft which can be made of any suitable material, such as plastic or metal. The shaft can be made of two or more smaller sections joined together.

The stylus (44) is hollow and has an aperture (50), as shown in FIG. 7. The illumination device (52) is positioned inside the stylus and the light (46) emitted by the illumination device (52) when it is activated is projected through the aperture (50) in the stylus (44). The stylus (44) is sufficiently large to accommodate at least a top portion of the illumination device (52). In other embodiments, the illumination device (52) is positioned in the housing (42) adjacent the stylus (44) such that the illumination device does not occupy any part of the stylus.

To turn on the illumination device (52), the stylus (44) is pressed down and released with sufficient force to press down and release the illumination device (52) through the stylus. In order to turn off the illumination device (52), the stylus (44) is pressed down on in the same manner. The actuator of the illumination device (52) is configured such that the force required to depress the illumination device (52) to turn it on or off is greater than the force required to press the stylus (44) against a touch screen and generate sufficient contact for interaction. This minimizes the risk of inadvertently actuating the illumination device while using the stylus.

As noted above, the illumination device (52) may be turned on and off via any other suitable actuation mechanism.

In the exemplary embodiment shown in FIG. 6, the multifunctional device (40) also includes an attachment member (48) positioned at the end of the housing (42) opposite to the stylus end. The attachment member (48) is configured to attach the multifunctional device (40) to various objects, such as, e.g., a user's belt loops, keychain, etc. to facilitate carrying the device and to ensure it is not lost by the user. The suitable attachment member may be used, such as a carabiner illustrated in FIG. 6.

It should be understood that the foregoing is illustrative and not limiting, and that obvious modifications may be made by those skilled in the art without departing from the spirit of the invention. Accordingly, reference should be made primarily to the accompanying claims, rather than the foregoing specification, to determine the scope of the invention.

What is claimed is:

1. A multifunctional instrument comprising:
a housing;
a writing member positioned in the housing with a writing tip accessible from the housing;
a stylus positioned at one end of the housing and having an aperture; and
an illumination device that emits a light through the aperture in the stylus when activated.

2. The multifunctional instrument of claim 1, wherein the illumination device is positioned inside the stylus.

3. The multifunctional instrument of claim 1, wherein the illumination device is positioned inside the housing adjacent the stylus.

4. The multifunctional instrument of claim 1, wherein the stylus is positioned at a proximal end of the housing and the writing member is positioned at a distal end of the housing.

5. The multifunctional instrument of claim 1, wherein both the stylus and the writing tip are positioned at the same end of the housing.

6. The multifunctional instrument of claim 5, wherein the writing tip extends out of the aperture in the stylus when in an activated position.

7. The multifunctional instrument of claim 5, wherein the illumination device emits a light through the aperture when the writing tip is positioned inside the stylus in an inactivated position.

8. The multifunctional instrument of claim 5, wherein the illumination device is positioned around the writing tip.

9. The multifunctional instrument of claim 5, wherein the illumination device is positioned behind the writing tip such that it emits light ahead of the writing tip.

10. The multifunctional instrument of claim 5, wherein the illumination device emits light when the writing tip is extended out of the housing in an activated position.

11. The multifunctional instrument of claim 1, wherein the illumination device is activated and deactivated by depressing and releasing the illumination device.

12. The multifunctional instrument of claim 1, wherein the illumination device is activated and deactivated by depressing and releasing the stylus.

13. The multifunctional instrument of claim 1, wherein the writing tip comprises at least one of a ball point tip, a fountain tip, a pencil tip, a felt tip, a marker tip, and a stylus tip.

14. The multifunctional instrument of claim 1, wherein the writing tip extends out of the housing when in an activated position and retracts inside the housing when in an inactivated position.

15. A multifunctional instrument comprising:
a housing;
a stylus positioned at one end of the housing and having an aperture; and
an illumination device that emits a light through the aperture when activated.

16. The multifunctional instrument of claim 15, wherein the illumination device is positioned inside the stylus.

17. The multifunctional instrument of claim 15, wherein the illumination device is positioned inside the housing.

18. The multifunctional instrument of claim 15, wherein the illumination device is activated and deactivated by depressing and releasing the illumination device.

19. The multifunctional instrument of claim 15, wherein the illumination device is activated and deactivated by depressing and releasing the stylus.

20. The multifunctional instrument of claim 15, wherein the illumination device is an LED.

21. The multifunctional instrument of claim 15, further comprising a writing member having a writing tip.

22. The multifunctional instrument of claim 15, wherein the stylus is positioned at a proximal end of the housing and the writing member is positioned at a distal end of the housing.

23. The multifunctional instrument of claim 15, wherein both the stylus and the writing tip are positioned at the same end of the housing.

24. The multifunctional instrument of claim 15, further comprising a removable cap member adapted to be positioned over at least one of the distal end and the proximal of the housing.
